(19) United States
(12) Patent Application Publication
(10) Pub. No.: US 2025/0283530 A1
(43) Pub. Date: Sep. 11, 2025

(54) Speed Reducer

(71) Applicant: Zhejiang Xiasha Precision Manufacturing Co., Ltd., Ningbo (CN)

(72) Inventors: Dayou Liu, Ningbo (CN); Guiping Xie, Ningbo (CN); Jianmin Xia, Ningbo (CN)

(21) Appl. No.: 19/218,496

(22) Filed: May 26, 2025

Related U.S. Application Data
(63) Continuation of application No. PCT/CN2022/137952, filed on Dec. 9, 2022.

(30) Foreign Application Priority Data
Dec. 5, 2022 (CN) 202211549585.3

(51) Int. Cl. F16H 49/00

(52) U.S. Cl. CPC F16H 49/001; F16H 2049/003

(57) ABSTRACT

A speed reducer has a housing (1), an input shaft (2), a fluctuating wheel (3), an output member and an annular elastic gear (5). The elastic gear (5) is located inside the chamber (10) and sleeved around the input shaft (2). An outer edge of the elastic gear (5) is fixed relative to the housing (1). The elastic gear (5) is located between the fluctuating wheel (3) and the output member, and under the driving of the fluctuating wheel (3), the portion is capable of elastically protruding toward the output member along an axis of the input shaft (2), so as to drive the output member to rotate around the central axis of the input shaft (2). An output power of the output member is balanced relative to an input power of the input shaft, so that the bearing capacity of the speed reducer is ensured.

### TECHNICAL FIELD OF THE INVENTION

The present invention relates to a gear speed reducer, and in particular to a speed reducer with an elastic gear.

### BACKGROUND OF THE INVENTION

At present, a reduction system comprises a motor and a speed reducer, wherein the motor drives an input member of the speed reducer through an input shaft, and the speed reducer decelerates an input from the motor and transfers the decelerated motion to an output shaft which is connected to a device to be driven.

In a harmonic speed reducer, a flexspline is a core component. For example, a Chinese Patent CN113078773A (patent No.: CN202010005474.0) entitled MOTOR WITH REDUCER EMBEDDED THEREIN disclosed a motor with a speed reducer embedded. The motor comprises: a housing; an input mechanism arranged in the housing and comprising a stator and a rotor, the stator being attached to an inner wall of the housing; a reduction device arranged in the housing and comprising a driving member and a driven member, the driving member being located in the rotor of the input mechanism and fixedly connected to the rotor; and, an output shaft driven by the driven member of the reduction device. The reduction device is a harmonic speed reducer, and the harmonic speed reducer comprises: a circular spline fixedly connected to the housing; a flexspline disposed on an inner circumferential side of the circular spline; an output shaft being fixedly connected to the flexspline; and, a wave generator arranged on an inner side of the flexspline and pressed against the inner side of the flexspline. The wave generator is connected to and driven by the annular input mechanism. The wave generator is a component that makes a controllable elastic deformation on the flexspline. When the wave generator is installed in the flexible wheel, the wave generator makes a cross section of the flexspline to deform from an original circular shape to an elliptical shape, teeth near both ends of a long axis of the wave generator are completely engaged with teeth of the circular spline. The teeth near both ends of a short axis of the wave generator are completely disengaged from the circular spline, and teeth in other sections are in a transition state between engagement and disengagement. The wave generator, the flexspline and the circular spline are sequentially sleeved on the input shaft. When the harmonic speed reducer operates, the flexspline deforms continuously with a rotation of the wave generator, and a meshing state of the flexspline and the circular spline also changes continuously, so that the flexspline slowly rotates relative to the circular spline in a direction opposite to the rotation direction of the wave generator, thus realizing speed reduction.

In the above parent, although speed reduction is ensured by a coordination of the circular spline (impeller) with the harmonic flexspline, the wave generation needs to makes the cross section of the flexspline to deform from the original circular shape to the elliptical shape. At this time, the flexspline needs to bear a larger force before it can be integrally pressed in the radial direction to form the elliptical shape (that is, a closed structure). Therefore, higher requirements are set for the wave generator, and it is easy to shorten the service life of the wave generator and reduce efficiency. In addition, due to the limitation by the closed structure of the annular member, the flexspline of the harmonic speed reducer is difficultly made of a material with higher strength and generally made of medium-carbon alloy steel represented by Ni element, so that the flexspline cannot bear a larger load during output.

Therefore, there is a need for further improvement of the existing speed reducers.

### SUMMARY OF THE INVENTION

It is an object of the present invention to provide a speed reducer which can improve a bearing capacity and prolong a service life of a fluctuating wheel.

For achieving the above object, the speed reducer comprises:
a housing having an inner chamber;
an input shaft having a central axis and rotatably connected to the housing;
a fluctuating wheel sleeved around the input shaft and rotatable together with the input shaft;
an output member rotatably connected to the input shaft;
an annular elastic gear having an inner edge and an outer edge;
wherein, a part of the input shaft is located inside the chamber and is capable of rotating around the central axis of the input shaft relative to the housing; the elastic gear is located inside the chamber and sleeved around the input shaft, one of the inner edge or the outer edge of the elastic gear is fixed relative to the housing, and the other one thereof is disposed between the fluctuating wheel and the output member and is engaged with the output member; at least a portion of the elastic gear which is located between the fluctuating wheel and the output member is elastic, and under the driving of the fluctuating wheel the portion is capable of elastically protruding toward the output member along the axis of the input shaft, so as to drive the output member to rotate around the central axis of the input shaft.

A rotation of the output member can be realized through many ways during an elastic deformation of the elastic gear. For example, the rotation of the output member can be realized by a permanent magnet as described in a Chinese Patent CN215733987U (patent No.: ZL202122165198.7), or can be realized by two meshed gears. However, considering the perspective of operation reliability, preferably, the output member is an annular output gear disk sleeved around the input shaft, the output gear disk has a ring of output gear teeth surrounding the input shaft at a surface facing toward the elastic gear; the elastic gear has a ring of input gear teeth surrounding the input shaft and located at the portion which is located between the fluctuating wheel and the output member, the ring of input gear teeth is located between the fluctuating wheel and the output gear teeth, and under the driving of the fluctuating wheel, some of the input gear teeth are driven to protrude toward the output gear disk together with the elastic portion of the elastic gear, so as to engage with the corresponding output gear teeth.

During a rotation of the fluctuating wheel, the elastic gear is continuously pressed, so that the corresponding position of the elastic gear is elastically protruding downward, accordingly, a corresponding part of the input gear teeth moves downward to engage with the output gear teeth, and the rest of the input gear teeth are not engaged with the output gear teeth. Thus, during the rotation of the fluctuating wheel, the input gear teeth of the elastic gear circularly engage with the output gear teeth along a circumferential direction of the elastic gear in turn, so as to drive the output gear disk to rotate about the central axis of the input shaft.

The elastic gear may have many structural forms, and the design of the elastic gears in the prior art can be used. As a first design of elastic gear, the elastic gear comprises an inner annulus and an outer annulus surrounding the inner annulus; the inner annulus is gradually inclined toward the output member from inside to outside, the input gear teeth are disposed on a bottom surface of the inner annulus, and the outer annulus is connected to the housing. An outer edge of the elastic gear is fixedly connected relative to the housing.

To make the elastic gear have better rigidity after deformation, preferably, a thickness of the inner annulus excluding the input gear teeth is less than a thickness of the outer annulus. In addition, it is advantageous for the elastic gear after deformation to reliably drive the rotation of the output member.

To ensure the reliability of the rotation of the output gear disk, preferably, the speed reducer further comprising a connecting member fixed relative to the housing, a center portion of the connecting member is connected to the input shaft, the output gear disk is disposed around the connecting member.

As a second design of the elastic gear, the input shaft has an extension portion protruding outward from an outer peripheral wall of the input shaft, the fluctuating wheel is connected to the extension portion and around the extension portion, the elastic gear comprises a first annular segment and a second annular segment around the first annular segment, the second annular segment is gradually inclined away from the output member from inside to outside, the first annular segment and the second annular segment are both located between the connecting member and the extension portion, the input gear teeth are disposed on the second annular segment. An inner side of the elastic gear is connected relative to the housing through the connecting member.

To reliably drive the rotation of the output gear disk, preferably, the connecting member is disposed inside the chamber, a fourth bearing is disposed between the connecting member and the housing, and a fifth bearing is disposed between the connecting member and the input shaft; the fifth bearing has a first ring and a second ring which are distributed alternatingly from inside to outside, the fourth bearing has an outer ring and an inner ring, the outer ring of the fourth bearing is connected to the output gear disk, the inner ring of the fourth bearing and the second ring of the fifth bearing are respectively connected to the connecting member.

To facilitate the connection to a device to be decelerated, preferably, a connecting piece is disposed outside the housing, the outer ring of the fourth bearing is disposed between the output gear disk and the connecting piece and is connected to the connecting piece.

To reliably ensure a deformation of the elastic position of the elastic gear where the part of the input gear teeth is located, preferably, a thickness of the second annular segment except the input gear teeth is less than a thickness of the first annular segment.

To simplify a calculation of a reduction ratio of the reducer, preferably, a total number of the input gear teeth is Z1, a total number of the output gear teeth is Z2, and a reduction ratio of the speed reducer is Z2: (Z1−Z2), where (Z1−Z2)≥1. When Z1−Z2=3, a pitch difference on a reference circle of the output toothed disc is 3/Z2; every time the elastic gear fluctuates, the output gear disk is pushed to move by 3/Z2 pitches; and, when the number of fluctuations of the output gear teeth (that is, the number of revolutions of the input shaft) is Z2, Z2*3/Z2=3, that is, the output gear disk is pushed to move by a pitch of three teeth, and the reduction ratio is Z2:3.

The elastic gear may have many ways to deform during the rotation of the fluctuating wheel. It is possible to provide a protruding portion on a surface of the fluctuating wheel facing toward the elastic gear, or it is also possible to provide a protruding portion on a surface of the elastic gear facing toward the fluctuating wheel. However, to facilitate the deformation of the elastic gear, preferably, the fluctuating wheel has at least one protruding portion on a surface of the fluctuating wheel facing toward the elastic gear, the protruding portion makes an elastic deformation at a position corresponding to the elastic gear and extends toward the elastic gear.

Two sidewalls of the protruding portion can be arc-shaped walls or inclined walls. However, preferably, the fluctuating wheel has two side walls which are arranged along a circumferential direction of the fluctuating wheel, each of the two side walls is an inclined wall, each inclined wall gradually inclines toward the opposite inclined wall from an end itself away from the elastic gear.

The two inclined walls of the protruding portion can be arranged symmetrically or asymmetrically. To realize more uniform deformation of the elastic gear, preferably, the two inclined walls of the protruding portion are symmetrically arranged and both are smoothly transitioning flat sections. Due to the flat sections, the elastic gear can be gradually pressed, so that the elastic gear is deformed.

To realize a smooth transition of two inclined walls of the protruding portion, preferably, the fluctuating wheel has a first arc surface, the two inclined walls of the protruding portion are smoothly connected by the first arc surface, the first arc surface is arched toward the elastic gear. At this time, when the protruding portion rotates with the fluctuating wheel, the protruding portion is more smoothly pressed against the elastic gear along the circumferential direction of the elastic gear, so that the output member rotates more stable and reliable.

The fluctuating wheel and the input shaft can be in the form of an integral piece or discrete pieces. However, to improve the rigidity of the fluctuating wheel, preferably, the fluctuating wheel and the input shaft are an integral piece.

To more smoothly press against the elastic gear along the circumferential direction, preferably, there are at least three protruding portions which are distributed alternatingly along a circumferential direction of the fluctuating wheel, the fluctuating wheel has a second arc surface, the inclined walls of two adjacent protruding portions are smoothly connected by the second arc surface, each second arc surface is arched toward the elastic gear. The elastic gear is smoothly deformed sequentially along the circumferential direction under the driving of the fluctuating wheel, so that the rotation of the output member is more stable and reliable. In addition, meshing occurs at three or more positions along the circumferential direction of the elastic gear (each protruding portion corresponds to one meshing), while the circular spline (output gear) and the flexspline in the background can only be meshed at two positions. Thus, the output member can bear larger power and torque, so that the bearing capacity of the speed reducer is improved. To reduce the friction and wear, preferably, a row of cylindrical roller bearings is arranged around the input shaft and is located between the fluctuating wheel and the input gear teeth. Due to the arrangement of the cylindrical roller bearings, rolling friction is generated between the cylindrical roller bearings and the elastic gear, thus making the elastic gear to fluctuate and deform.

Compared with the prior art, the speed reducer of the present invention has the following advantages. The elastic gear in the speed reducer is elastically deformable. The elastic gear, the fluctuating wheel and the output member are arranged along the axis of the input shaft. The fluctuating wheel rotates under the driving of the input shaft and enables the elastic portion (at the inner edge or outer edge) of the elastic gear to elastically protrude toward the output member, that is, the elastic portion (at the inner edge or outer edge) of the elastic gear is deformed along the central axis of the input shaft. In other words, the speed reducer of the present invention only requires one portion of the elastic gear to be elastically deformed, and the speed reducer uses an open structure. Under such design, only a small force can achieve the deformation of the elastic gear. Thus, the service life and efficiency of the fluctuating wheel are prolonged, the users' requirements can be satisfied, the problem of short service life of the fluctuating wheel caused by the fact that the fluctuating wheel needs to exert a larger pressure on the flexspline along a radial direction as stated in the background can be overcome, and the speed reducer of the present invention has an advantage of improving the bearing capacity.

In addition, compared with the flexspline, the elastic gear adopts an open structure in which the inner annulus or outer annulus is deformable, thus an elastic material with higher strength can be used. For example, it is possible to use high-carbon alloy steel represented by Si element.

Moreover, since the elastic gear is connected to the housing and fixed relative to the housing, when the output member is subjected to a reverse load, the output member will be self-locked, and it can prevent the output member from reversely rotating, therefore a good self-locking effect of such a transmitting device is ensured.

The speed reducer of the present invention can be used at a joint of a robot.

### BRIEF DESCRIPTION OF THE DRAWINGS

FIG. 1 is a perspective view of a speed reducer according to Embodiment 1 of the present invention;

FIG. 2 is a sectional view of the speed reducer in FIG. 1;

FIG. 3 is another sectional view of the speed reducer in FIG. 1;

FIG. 4 is an enlarged view of part-I in FIG. 3;

FIG. 5 is an exploded view of the speed reducer in FIG. 1;

FIG. 6 is a sectional view showing a fluctuating wheel, a deformed elastic gear with input gear teeth, and output gear teeth engaged with the input gear teeth in FIG. 1;

FIG. 7 is a perspective view of an elastic gear with input gear teeth;

FIG. 8 is a sectional view of the elastic gear in FIG. 7;

FIG. 9 is a perspective view of the input shaft and the fluctuating wheel;

FIG. 10 is a perspective view of the fluctuating wheel in FIG. 9;

FIG. 11 is a developed wave pattern of a surface of the fluctuating wheel where the protruding portions located in FIG. 9;

FIG. 12 is a sectional view of a speed reducer according to Embodiment 2 of the present invention;

FIG. 13 is a perspective view of an elastic gear in Embodiment 2 (a part is omitted); and

FIG. 14 is an enlarged view of part-II in FIG. 12.

### DETAILED DESCRIPTION OF THE INVENTION

The present invention will be further described below in detail by embodiments with reference to the accompanying drawings.

### Embodiment 1

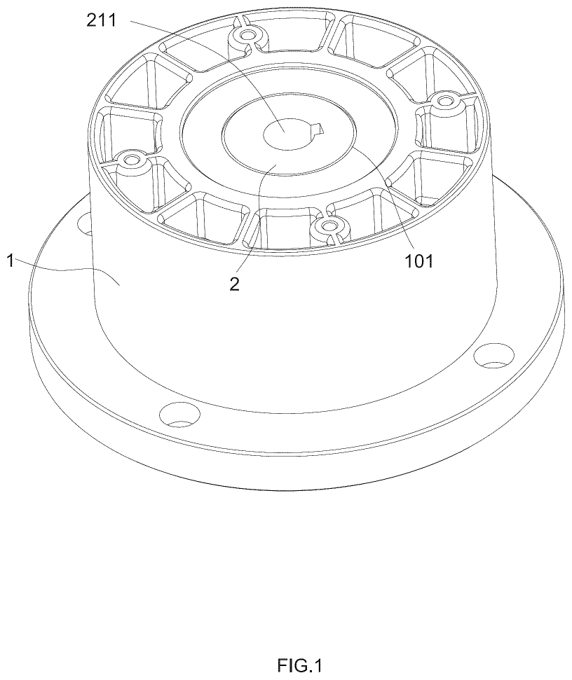

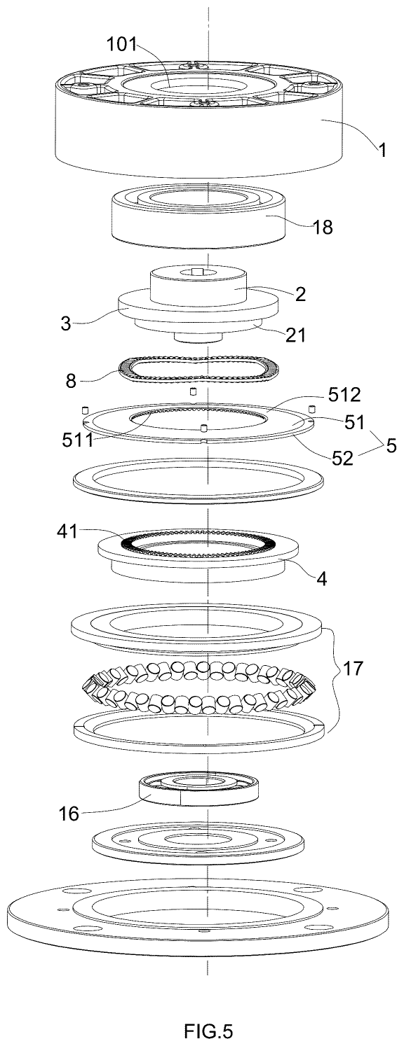

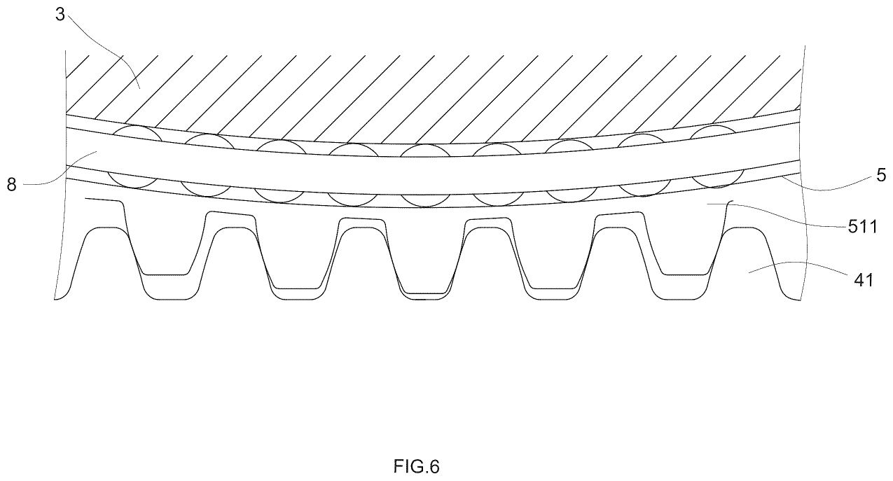

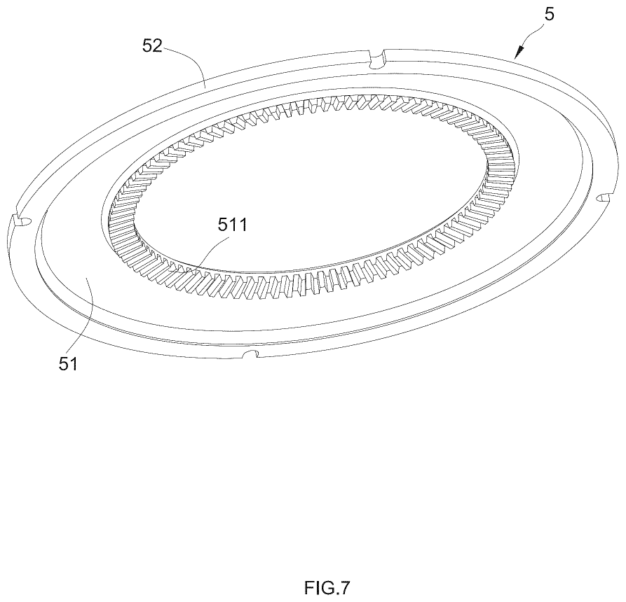

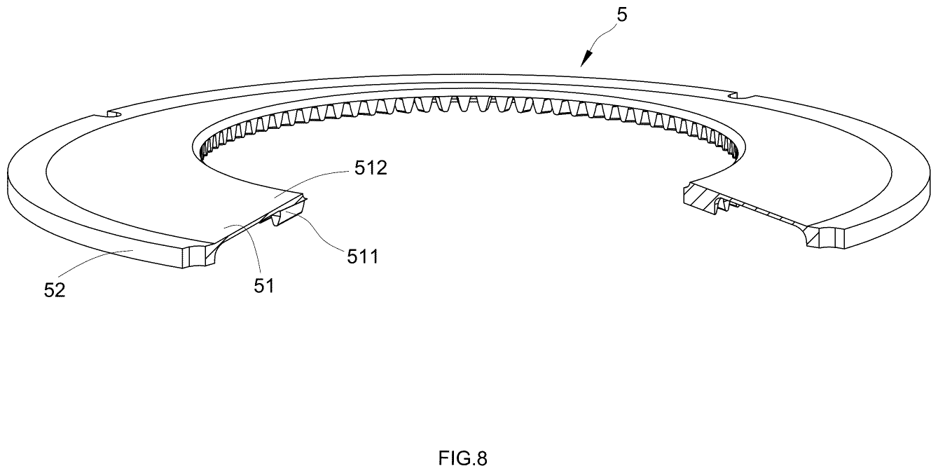

FIGS. 1-11 show a preferred Embodiment 1 of a speed reducer of the present invention. The speed reducer in this embodiment comprises a housing 1, an input shaft 2, a fluctuating wheel 3, an output gear disk 4 (as an output member in this embodiment) and an annular elastic gear 5.

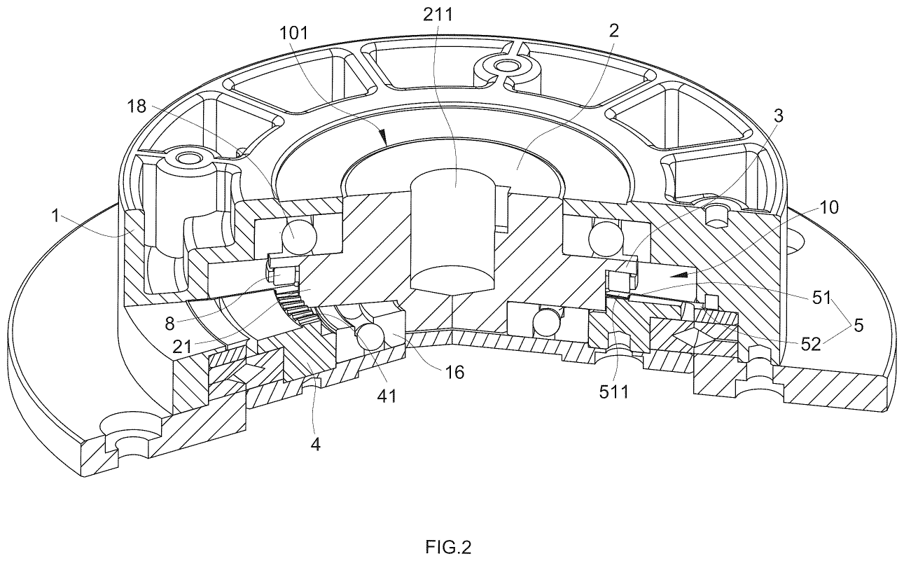

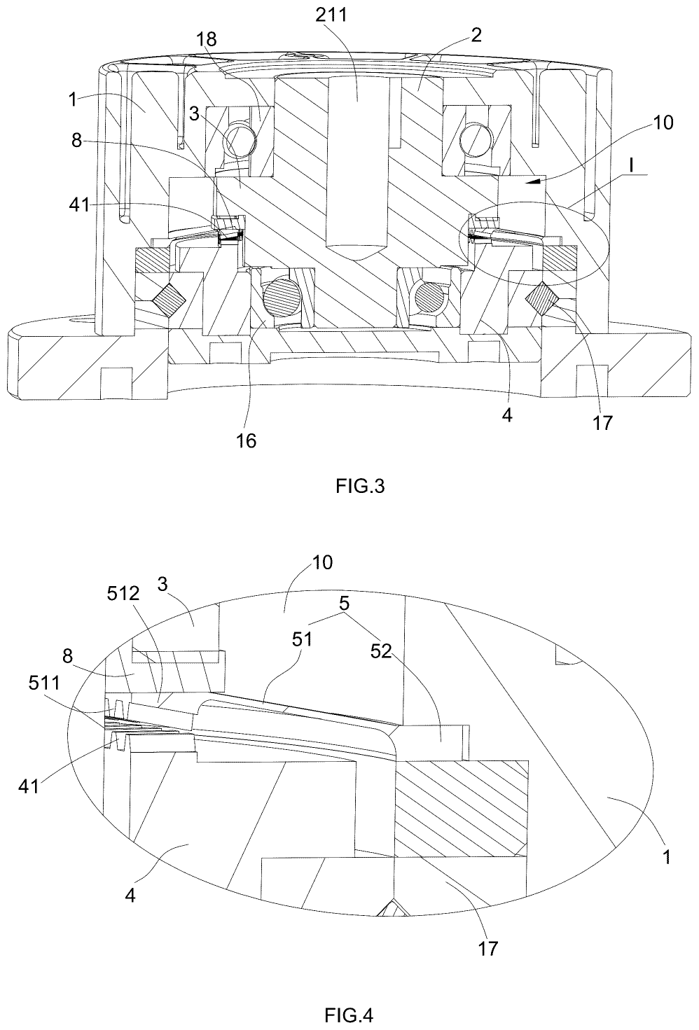

In this embodiment, the input shaft 2 extends vertically and has a central axis, and the input shaft 2 rotates around the central axis and a rotation axis of all parts of the input shaft 2 is just the same central axis of the input shaft 2. The housing 1 has an inner chamber 10 and a central hole 101 communicating with the chamber 10 at a top of the housing 1. As shown in FIGS. 2 and 3, the input shaft 2 locates in the central hole 101 and is partially located inside the chamber 10. The fluctuating wheel 3 is sleeved around the input shaft 2 and connected to the input shaft 2. As shown in FIGS. 2, 3, 9 and 10, in the embodiment the fluctuating wheel 3 and the input shaft 2 are an integral piece, and the elastic gear 5 is located between the fluctuating wheel 3 and the output gear disk 4, these three components are arranged along the central axis of the input shaft 2. The input shaft 2 has a mounting hole 211 for receiving an output shaft of a power source on the input shaft 2. The input shaft 2 rotates around the central axis of the input shaft 2 relative to the housing 1 under the driving of the power source, and a third bearing 18 is arranged between the input shaft 2 and the housing 1.

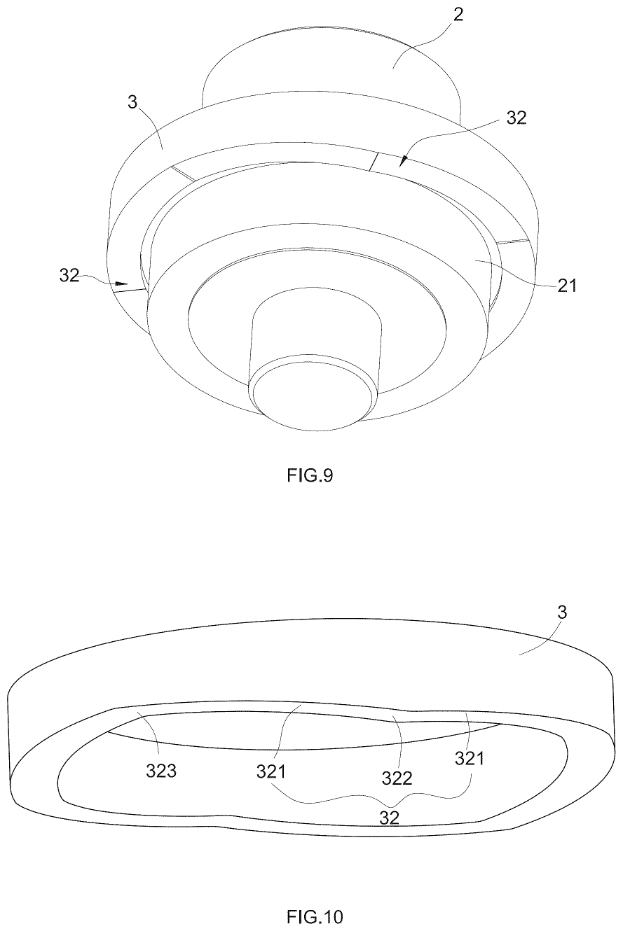

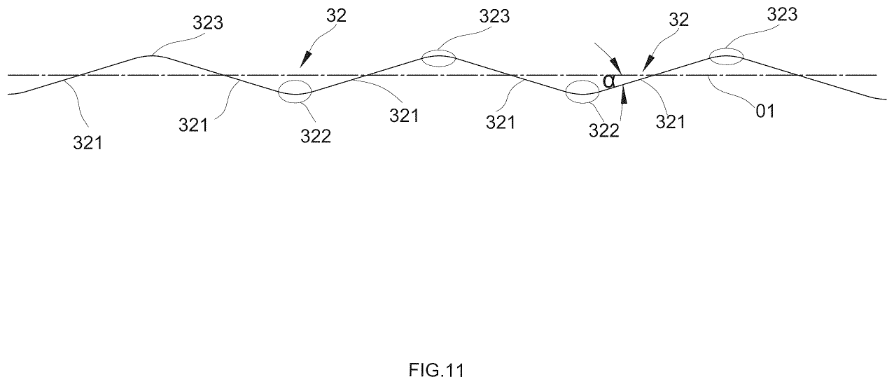

The fluctuating wheel 3 has at least one protruding portion 32 on an annular surface of the fluctuating wheel 3 facing toward the elastic gear 5, the protruding portion 32 makes an elastic deformation at a position corresponding to the elastic gear 5 and is disposed on a bottom surface of the fluctuating wheel 3. As shown in FIG. 9, in this embodiment, the fluctuating wheel 3 has three protruding portions 32 which are arranged alternatingly along a circumferential direction of the fluctuating wheel 3. In addition, it is also possible to have more than three protruding portions 32 on the fluctuating wheel 3. The protruding portions 32 are the same in structure, and the following description is given by taking one protruding portion 32 as an example. The protruding portion 32 is arranged away from an outer edge of the elastic gear 5 and extends downward toward the elastic gear 5. The fluctuating wheel 3 has two side walls 321 which are arranged along the circumferential direction of the fluctuating wheel 3, each of the two side walls 321 is an inclined wall 321, each inclined wall 321 gradually inclines toward the opposite inclined wall 321 from an end itself away from the elastic gear 5. As shown in FIG. 11, the two inclined walls 321 of the protruding portion 32 in this embodiment are symmetrically arranged and both are smoothly transitioning flat sections, and an included angle formed between each inclined wall 321 and a plane 01 perpendicular to the input shaft 2 is the fluctuation angle α. To ensure a smooth transition of the two inclined walls 321 of the protruding portion 32, the fluctuating wheel 3 has a first arc surface 322, the two inclined walls 321 of each protruding portion 32 are smoothly connected by the first arc surface 322. The first arc surface 322 is arched toward the elastic gear 5 (that is, the first arc surface 322 is arched downward as shown in figures). The fluctuating wheel 3 has a second arc surface 323, the inclined walls 321 of two adjacent protruding portions 32 are smoothly connected by the second arc surface 323. Each second arc surface 323 is arched toward the elastic gear 5 (that is, each second arc surface 323 is arched upward as shown in figures). When the protruding portions 32 rotate with the fluctuating wheel 3, the elastic gear 5 is smoothly deformed along a circumferential direction of the elastic gear 5 under the driving of the fluctuating wheel 3, so that the output member rotates more stable and reliable.

As shown in FIGS. 2, 3, 7 and 8, the elastic gear 5 is located inside the chamber 10 and sleeved around the input shaft 2, and an outer edge of the elastic gear 5 is fixedly connected to the housing 1 and is elastically deformable. Specifically, the elastic gear 5 comprises an inner annulus 51 and an outer annulus 52 surrounding the inner annulus 51; the inner annulus 51 is gradually inclined toward the output gear disk from inside to outside (that is, the inner annulus 51 is gradually inclined downward), and the outer annulus 52 is connected to the housing 1.

To drive the output member to rotate during fluctuation and deformation of the elastic gear 5, in this embodiment, the output member is an annular output gear disk 4 sleeved around the input shaft 2. The output gear disk 4 has a ring of output gear teeth 41 surrounding the input shaft 2 at a surface facing toward the elastic gear 5. The output gear teeth 41 are located on an upper surface of the output gear disk 4, and surround the input shaft 2. The elastic gear 5 has a ring of input gear teeth 511 surrounding the input shaft 2 and the input gear teeth 511 is located at a portion which is located between the fluctuating wheel 3 and the output gear disk 4. That is, the input gear teeth 511 are located on an inner side of a lower surface of the inner annulus 51 of the elastic gear 5, surround the input shaft 2 and are located below the protruding portions 32. Under an action of the inclined walls 321 of the protruding portions 32, the input gear teeth 511 can be deformed downward to engage with the corresponding output gear teeth 41. During a rotation of the output gear disk 4, the input gear teeth 511 sequentially protrude to engage with the corresponding output gear teeth 41.

To make the elastic gear 5 have better rigidity after deformation, a thickness of the inner annulus 51 excluding the input gear teeth 511 is less than a thickness of the outer annulus 52, so that it is advantageous for the elastic gear 5 after deformation to reliably drive the output gear disk 4 to rotate. A first bearing 16 is arranged between the output gear disk 4 and the input shaft 2, and a second bearing 17 is arranged between the output gear disk 4 and an inner side of the housing 1.

Since the input gear teeth 511 on the elastic gear 5 are located between the protruding portions 32 on the fluctuating wheel 3 and the output gear disk 4, during a rotation of the fluctuating wheel 3, the inclined walls 321 of the protruding portions 32 are continuously pressed against the portion of the elastic gear 5 where a part of the input gear teeth 511 is located, so that the part of the input gear teeth 511 move downward to engage with the corresponding output gear teeth 41, and a rest of the input gear teeth 511 are not engaged with the corresponding output gear teeth 41. During the rotation of the fluctuating wheel 3, the part of the input gear teeth 511 of the elastic gear 5 engages with the corresponding output gear teeth 41 along a circumferential direction of the input gear teeth 511, so as to drive the output gear disk 4 to rotate about the central axis of the input shaft 2.

To simplify a calculation of the reduction ratio of the speed reducer, a total number of the input gear teeth 511 is Z1, a total number of the output gear teeth 41 is Z2, and a reduction ratio of the speed reducer is Z2: (Z1−Z2), where (Z1−Z2)≥1. However, to avoid the problem of relatively poor load force caused by unilateral meshing between the elastic gear 5 and the output gear disk 4, it is required that (Z1−Z2)≥2. In this embodiment, Z1−Z2=3, and a pitch difference on a reference circle of the output gear disk 4 is 3/Z2. Every time the elastic gear 5 fluctuates, the output gear disk 4 is pushed to move by 3/Z2 pitches; and, when the number of fluctuations of the output gear teeth 41 (that is, the number of revolutions of the input shaft 2) is Z2, the output gear teeth 41 are pushed to move by a pitch of three teeth, and the reduction ratio is Z2:3.

The input shaft 2 has an extension portion 21 protruding outward from an outer peripheral wall of the input shaft 2, the fluctuating wheel 3 is connected to the extension portion 21 and around the extension portion 21. To reduce the friction and wear, a row of cylindrical roller bearings 8 is arranged around the extension portion 21 of the input shaft 2 and is located between the fluctuating wheel 3 and the input gear teeth 511. Due to the arrangement of the cylindrical roller bearings 8, rolling friction is generated between a bottom of the cylindrical roller bearings 8 and the elastic gear 5, making the elastic gear 5 to fluctuate and deform, and rolling friction is generated between a top of the cylindrical roller bearings 8 and the fluctuating wheel 3.

The elastic gear 5 in the speed reducer is elastically deformable. The elastic gear 5, the fluctuating wheel 3 and the output member (the output gear disk 4) are arranged along the axis of the input shaft 2. The fluctuating wheel 3 rotates under the driving of the input shaft 2 and enables the elastic portion (at the inner edge or outer edge) of the elastic gear 5 to elastically protrude toward the output member, that is, the elastic portion (at the inner edge or outer edge) of the elastic gear 5 is deformed along the central axis of the input shaft 2. In other words, the speed reducer only requires one portion of the elastic gear to be elastically deformed, and the speed reducer uses an open structure. Under such design, only a small force can achieve the deformation of the elastic gear. Thus, the service life and efficiency of the fluctuating wheel 3 are prolonged, the users' requirements can be satisfied, the problem of short service life of the fluctuating wheel 3 caused by the fact that the fluctuating wheel 3 needs to exert a larger pressure on the flexspline along a radial direction as stated in the background can be overcome. In addition, compared with the flexspline, the elastic gear 5 adopts an open structure in which the inner annulus 51 or outer annulus 52 is deformable, thus an elastic material with higher strength can be used. For example, it is possible to use high-carbon alloy steel represented by Si element. Moreover, since the elastic gear 5 is fixedly connected to the housing 1, when subjected to a reverse load, the output member will be self-locked, and it can prevent the output member from reversely rotating, therefore a good self-locking effect of such a transmitting device is ensured.

### Embodiment 2

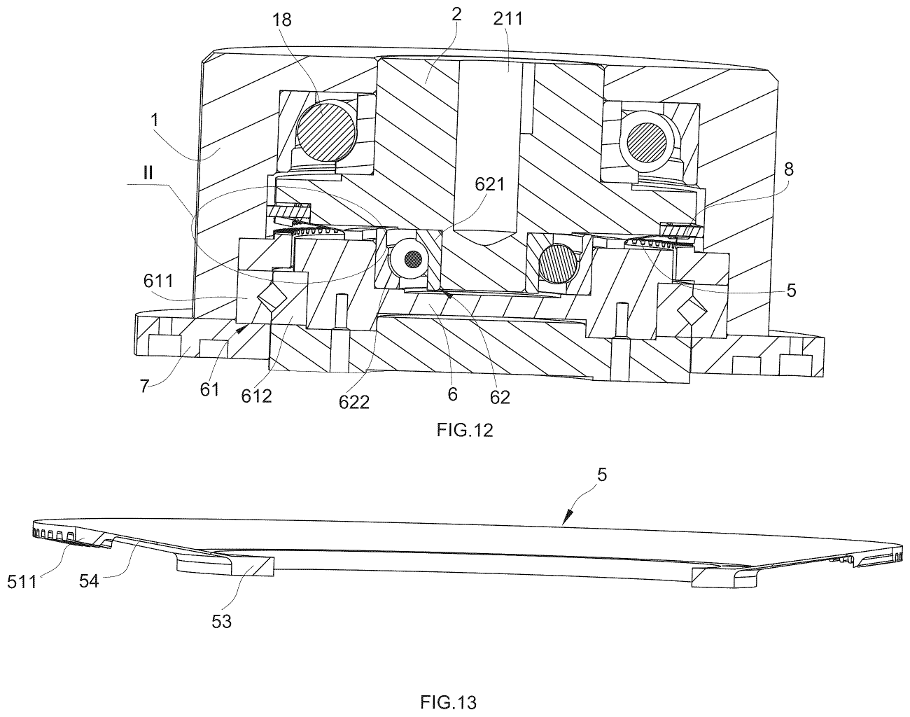

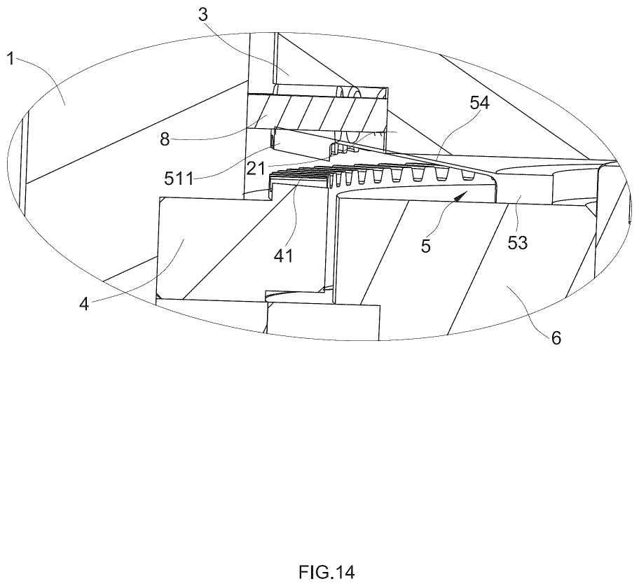

FIGS. 12-14 show a preferred Embodiment 2 of a speed reducer of the present invention.

This embodiment differs from Embodiment 1 in that: the specific structure of the elastic gear 5 in this embodiment is different from that in Embodiment 1. Specifically, the elastic gear 5 comprises a first annular segment 53 and a second annular segment 54 around the first annular segment 53, the second annular segment 54 is gradually inclined away from the output member from inside to outside, the first annular segment 53 and the second annular segment 54 are both located between a connecting member 6 and the extension portion 21. An outer edge of the elastic gear 5 is fixed relative to a housing 1, and the first annular segment 53 is fixed relative to the connecting member 6. Input gear teeth 511 are disposed on a second annular segment 54., and a thickness of the second annular segment 54 except the input gear teeth 511 is less than a thickness of a first annular segment 53. A fluctuating wheel 3 rotates under the driving of the input shaft 2, and a portion of the elastic gear 5 which is located between the fluctuating wheel 3 and the output gear disk 4 elastically protrudes toward the output gear disk 4.

The speed reducer further comprises the connecting member 6 fixed relative to the housing 1, and a center portion of the connecting member 6 is connected to the input shaft 2. The output gear disk 4 is disposed around the connecting member 6. Specifically, a fourth bearing 61 is disposed between the connecting member 6 and the housing 1, and a fifth bearing 62 is disposed between the connecting member 6 and the input shaft 2. The fifth bearing 62 has a first ring 621 and a second ring 622 which are distributed alternatingly from inside to outside. The fourth bearing 61 has an outer ring 611 and an inner ring 612, the outer ring 611 of the fourth bearing 61 is connected to the output gear disk 4, the inner ring 612 of the fourth bearing 61 and the second ring 622 of the fifth bearing 62 are respectively connected to the connecting member 6. In addition, a connecting piece 7 is disposed outside the housing 1, the outer ring 611 of the fourth bearing 61 is disposed between the output gear disk 4 and the connecting piece 7 and is connected to the connecting piece 7, so that the output gear disk 4 is fixed relative to the connecting piece 7. At this time, the output gear disk 4 rotates to drive the connecting piece 7 to rotate. The connecting piece 7 is connected to an external device that needs to be driven by the speed reducer, and the speed reducer can be used at a joint of a robot.

It should be noted that in the description and claims of the present invention, the terms used to indicate direction, such as “front, back”, “up, down”, “left, right”, “side, top, bottom”, etc. are used to describe structures and elements of the present invention for better explanation. And these terms used here are based on an orientation in the accompanying drawings. Since the embodiments disclosed by the present invention can be set in different directions, these terms indicating directions are only used as explanations and should not be used as restrictions. For example, the verbs “up”, “down” should not be limited to the direction opposite or consistent with the gravity.

1. A speed reducer, comprising:
a housing (1) having an inner chamber (10);
an input shaft (2) having a central axis and rotatably connected to the housing (1);
a fluctuating wheel (3) sleeved around the input shaft (2) and rotatable together with the input shaft (2);
an output member rotatably connected to the input shaft (2);
an annular elastic gear (5) having an inner edge and an outer edge;
wherein,
a part of the input shaft (2) is located inside the chamber (10) and is capable of rotating around the central axis of the input shaft (2) relative to the housing (1);
the elastic gear (5) is located inside the chamber (10) and sleeved around the input shaft (2), one of the inner edge or the outer edge of the elastic gear (5) is fixed relative to the housing (1), and the other one thereof is disposed between the fluctuating wheel (3) and the output member and is engaged with the output member;
at least a portion (512) of the elastic gear (5) which is located between the fluctuating wheel (3) and the output member is elastic, and under the driving of the fluctuating wheel (3), the portion (512) is capable of elastically protruding toward the output member along the axis of the input shaft (2), so as to drive the output member to rotate around the central axis of the input shaft (2).

2. The speed reducer of claim 1, wherein the output member is an annular output gear disk (4) sleeved around the input shaft (2), the output gear disk (4) has a ring of output gear teeth (41) surrounding the input shaft (2) at a surface facing toward the elastic gear (5);
the elastic gear (5) has a ring of input gear teeth (511) surrounding the input shaft (2) and located at the portion (512) which is located between the fluctuating wheel (3) and the output member, the ring of input gear teeth (511) is located between the fluctuating wheel (3) and the output gear teeth (41), and under the driving of the fluctuating wheel (3), some of the input gear teeth (511) are driven to protrude toward the output gear disk (4) together with the elastic portion (512) of the elastic gear (5), so as to engage with the corresponding output gear teeth (41).

3. The speed reducer of claim 2, wherein the elastic gear (5) comprises an inner annulus (51) and an outer annulus (52) surrounding the inner annulus (51);
the inner annulus (51) is gradually inclined toward the output member from inside to outside, the input gear teeth (511) are disposed on a bottom surface of the inner annulus (51), and the outer annulus (52) is connected to the housing (1).

4. The speed reducer of claim 3, wherein a thickness of the inner annulus (51) excluding the input gear teeth (511) is less than a thickness of the outer annulus (52).

5. The speed reducer of claim 2, wherein the speed reducer further comprising a connecting member (6) fixed relative to the housing (1), a center portion of the connecting member (6) is connected to the input shaft (2), the output gear disk (4) is disposed around the connecting member (6).

6. The speed reducer of claim 5, wherein the input shaft (2) has an extension portion (21) protruding outward from an outer peripheral wall of the input shaft (2), the fluctuating wheel (3) is connected to the extension portion (21) and around the extension portion (21), the elastic gear (5) comprises a first annular segment (53) and a second annular segment (54) around the first annular segment (53), the second annular segment (54) is gradually inclined away from the output member from inside to outside, the first annular segment (53) and the second annular segment (54) are both located between the connecting member (6) and the extension portion (21), the input gear teeth (511) are disposed on the second annular segment (54).

7. The speed reducer of claim 5, wherein the connecting member (6) is disposed inside the chamber (10), a fourth bearing (61) is disposed between the connecting member (6) and the housing (1), and a fifth bearing (62) is disposed between the connecting member (6) and the input shaft (2);
the fifth bearing (62) has a first ring (621) and a second ring (622) which are distributed alternatingly from inside to outside, the fourth bearing (61) has an outer ring (611) and an inner ring (612), the outer ring (611) of the fourth bearing (61) is connected to the output gear disk (4), the inner ring (612) of the fourth bearing (61) and the second ring (622) of the fifth bearing (62) are respectively connected to the connecting member (6).

8. The speed reducer of claim 7, wherein a connecting piece (7) is disposed outside the housing (1), the outer ring (611) of the fourth bearing (61) is disposed between the output gear disk (4) and the connecting piece (7) and is connected to the connecting piece (7).

9. The speed reducer of claim 6, wherein a thickness of the second annular segment (54) except the input gear teeth (511) is less than a thickness of the first annular segment (53).

10. The speed reducer of claim 2, wherein a total number of the input gear teeth (511) is Z1, a total number of the output gear teeth (41) is Z2, and a reduction ratio of the speed reducer is Z2: (Z1−Z2), where (Z1−Z2)≥1.

11. The speed reducer of claim 1, wherein the fluctuating wheel (3) has at least one protruding portion (32) on a surface of the fluctuating wheel (3) facing toward the elastic gear (5), the protruding portion (32) makes an elastic deformation at a position corresponding to the elastic gear (5) and extends toward the elastic gear (5).

12. The speed reducer of claim 11, wherein the fluctuating wheel (3) has two side walls (321) which are arranged along a circumferential direction of the fluctuating wheel (3), each of the two side walls (321) is an inclined wall (321), each inclined wall (321) gradually inclines toward the opposite inclined wall (321) from an end itself away from the elastic gear (5).

13. The speed reducer of claim 12, wherein the two inclined walls (321) of the protruding portion (32) are symmetrically arranged and both are smoothly transitioning flat sections.

14. The speed reducer of claim 12, wherein the fluctuating wheel (3) has a first arc surface (322), the two inclined walls (321) of the protruding portion (32) are smoothly connected by the first arc surface (322), the first arc surface (322) is arched toward the elastic gear (5).

15. The speed reducer of claim 11, wherein the fluctuating wheel (3) and the input shaft (2) are an integral piece.

16. The speed reducer of claim 12, wherein there are at least three protruding portions (32) which are distributed to along a circumferential direction of the fluctuating wheel (3), the fluctuating wheel (3) has a second arc surface (323), the inclined walls (321) of two adjacent protruding portions (32) are smoothly connected by the second arc surface (323), each second arc surface (323) is arched toward the elastic gear (5).

17. The speed reducer of claim 10, wherein a row of cylindrical roller bearings (8) is arranged around the input shaft (2) and is located between the fluctuating wheel (3) and the input gear teeth (511).
